(19) United States
(12) Patent Application Publication
(10) Pub. No.: US 2026/0094862 A1
(43) Pub. Date: Apr. 2, 2026

(54) ELECTROLYTIC SOLUTION FOR LITHIUM METAL SECONDARY BATTERY

(71) Applicant: HONDA MOTOR CO., LTD., Tokyo (JP)

(72) Inventors: Takeshi FUJINO, Saitama (JP); Taku IMAIZUMI, Saitama (JP)

(21) Appl. No.: 19/269,062

(22) Filed: Jul. 15, 2025

(30) Foreign Application Priority Data
Sep. 30, 2024 (JP) 2024-171859

(51) Int. Cl. H01M 10/0525; H01M 10/056

(52) U.S. Cl. CPC H01M 10/0525; H01M 10/056; H01M 2300/002

(57) ABSTRACT

To provide an electrolytic solution for a lithium metal secondary battery capable of suppressing an increase in resistance of the lithium metal secondary battery, suppressing gas generation, and suppressing an increase in thickness of the negative electrode, when 1,2-dimethoxyethane (DME) is used as the solvent. An electrolytic solution for a lithium metal secondary battery comprising an electrolyte salt, an organic solvent, and at least one first additive, the electrolyte salt comprising lithium bis-fluorosulfonylimide (LiFSI), the organic solvent comprising 1,2-dimethoxyethane (DME), the at least one first additive being at least any one of N,N-dimethyltrifluoromethane-sulfonamide (DMTMSA) or N,N-dimethylsulfamoyl fluoride (DMSF), wherein the electrolytic solution for a lithium metal secondary battery comprises the first additive in an amount of 0.2 parts by mass or more when a total mass of the electrolyte salt and the organic solvent is 100 parts by mass.

This application is based on and claims the benefit of priority from Japanese Patent Application No. 2024-171859, filed on 30 Sep. 2024, the content of which is incorporated herein by reference.

### BACKGROUND OF THE INVENTION

### Field of the Invention

The present invention relates to an electrolytic solution for a lithium metal secondary battery.

### Related Art

In recent years, secondary batteries that contribute to energy efficiency have been researched and developed to ensure that more people have access to affordable, reliable, sustainable, and advanced energy. As the secondary batteries, lithium metal secondary batteries using lithium metal as a negative electrode have attracted attention.

In order to improve durability of a lithium metal secondary battery, a technique of forming a protective layer (SEI) on a surface of a negative electrode by using a composition of an electrolytic solution or an additive is known.

For the purpose of maintaining specific discharge capacity and/or coulombic efficiency of a lithium metal secondary battery after charge and discharge cycles at a predetermined value or more, a technique relating to an electrochemical device containing DMTMSA and/or LiFSI as a main component of an electrolyte has been proposed (for example, see Patent Document 1).
Patent Document 1: Japanese Unexamined Patent Application (Translation of PCT Application), Publication No. 2024-506963

### SUMMARY OF THE INVENTION

The technique disclosed in Patent Document 1 is, however, problematic from the viewpoint of, for example, suppression of an increase in resistance of a lithium metal secondary battery for a large-sized vehicle-mounted battery, suppression of gas generation, and suppression of an increase in thickness of the negative electrode. Specifically, an increase in the thickness of the lithium negative electrode due to charge and discharge leads to an increase in the cell size, which is problematic in that the energy density of the battery decreases. As a technique for reducing an increase in the thickness of the lithium negative electrode due to charge and discharge, there is a technique of increasing a restraining force of the battery to a predetermined restraining pressure or more, but there is a problem that a holding member for increasing the restraining force of the laminated electrode group becomes large, and the energy density of the battery cannot be increased. Therefore, there is a need for a technique of suppressing a change in volume of the negative electrode in the thickness direction by a means other than increasing the restraining force of the battery. Further, for example, it is required to suppress the thickness change by charging at 0.2 C to 1.5 C. Examples of solvents for electrolytes satisfying these requirements include 1,2-dimethoxyethane (DME), which has various advantages such as a reduction in cell resistance, wettability due to a low viscosity, and low cost. Use of DME has been required to be able to solve the above problems.

The present invention has been made in view of the above, and an object of the present invention is to provide an electrolytic solution for a lithium metal secondary battery capable of simultaneously suppressing an increase in resistance of a lithium metal secondary battery, suppressing gas generation, and suppressing an increase in thickness of the negative electrode when 1,2-dimethoxyethane (DME) is used as a solvent.

A first aspect of the present invention relates to an electrolytic solution for a lithium metal secondary battery, including an electrolyte salt, an organic solvent, and at least one first additive. The electrolyte salt includes lithium bis-fluorosulfonylimide (LiFSI), the organic solvent includes 1,2-dimethoxyethane (DME), and the at least one first additive is at least any one of N,N-dimethyltrifluoromethane-sulfonamide (DMTMSA) or N,N-dimethylsulfamoyl fluoride (DMSF). The electrolytic solution for a lithium metal secondary battery contains the first additive in an amount of 0.2 parts by mass or more when the total mass of the electrolyte salt and the organic solvent is 100 parts by mass.

According to the first aspect of the present invention, when 1,2-dimethoxyethane (DME) is used as the solvent, it is possible to provide an electrolytic solution for a lithium metal secondary battery capable of suppressing an increase in resistance of the lithium metal secondary battery, suppressing gas generation, and suppressing an increase in thickness of the negative electrode.

A second aspect of the present invention relates to the electrolytic solution for a lithium metal secondary battery as described in the first aspect, in which the electrolytic solution for a lithium metal secondary battery includes the first additive in an amount of 5.0 parts by mass or less when the total mass of the electrolyte salt and the organic solvent is 100 parts by mass.

According to the second aspect, the effects of suppressing an increase in resistance of the lithium metal secondary battery, suppressing gas generation, and suppressing an increase in thickness of the negative electrode of the lithium metal secondary battery are more preferably obtained.

A third aspect of the present invention relates to the electrolytic solution for a lithium metal secondary battery as described in the first or second aspect, in which the first additive includes both N,N-dimethyltrifluoromethane-sulfonamide (DMTMSA) and N,N-dimethylsulfamoyl fluoride (DMSF), and the content (mass ratio) of N,N-dimethyltrifluoromethane-sulfonamide (DMTMSA) is smaller than the content (mass ratio) of N,N-dimethylsulfamoyl fluoride (DMSF).

According to the third aspect, both the effect of suppressing an increase in the thickness of the negative electrode and the effect of improving the durability of the lithium metal secondary battery can be preferably obtained.

A fourth aspect of the present invention relates to the electrolytic solution for a lithium metal secondary battery as described in any one of the first to third aspects, further including, as a second additive, at least any one of lithium difluoro (oxalato) borate (LiFOB), lithium difluorophosphate (LiDFP), or LiPF₆.

According to the fourth aspect, the effects of suppressing an increase in resistance, suppressing gas generation, and suppressing an increase in thickness of the negative electrode of the lithium metal secondary battery are more preferably obtained.

A fifth aspect of the present invention relates to the electrolytic solution for a lithium metal secondary battery as described in any one of the first to fourth aspects, in which the content of 1,2-dimethoxyethane (DME) in the organic solvent is 20 mol % or more.

According to the fifth aspect, even when 1,2-dimethoxyethane (DME) is used as a main solvent, the effects of suppressing an increase in resistance of the lithium metal secondary battery, suppressing gas generation, and suppressing an increase in thickness of the negative electrode can be preferably obtained.

A sixth aspect of the present invention relates to the electrolytic solution for a lithium metal secondary battery as described in any one of the first to fifth aspects, further including a fluorinated ether as the organic solvent.

According to the sixth aspect, the effects of suppressing an increase in resistance, suppressing gas generation, and suppressing an increase in thickness of the negative electrode of the lithium metal secondary battery are more preferably obtained.

A seventh aspect of the present invention relates to the electrolytic solution for a lithium metal secondary battery as described in any one of the first to sixth aspects, in which the concentration of lithium bis-fluorosulfonylimide (LiFSI) as the electrolyte salt in the electrolytic solution for a lithium metal secondary battery is 1.2 mol/L or more and 2.5 mol/L or less.

According to the seventh aspect, the effects of suppressing an increase in resistance, suppressing gas generation, and suppressing an increase in thickness of the negative electrode of the lithium metal secondary battery are more preferably obtained.

According to the present invention, when 1,2-dimethoxyethane (DME) is used as a solvent, it is possible to provide an electrolytic solution for a lithium metal secondary battery capable of suppressing an increase in resistance of the lithium metal secondary battery, suppressing gas generation, and suppressing an increase in thickness of the negative electrode.

### DETAILED DESCRIPTION OF THE INVENTION

### <Electrolytic Solution for Lithium Metal Secondary Battery>

The electrolytic solution for a lithium metal secondary battery according to the present embodiment includes an electrolyte salt, an organic solvent, and a first additive. In addition, a second additive is preferably included.

As the electrolyte salt, it is essential that at least a part thereof has a structure of FSI (fluorosulfonylimide), and lithium bis-fluorosulfonylimide (LiFSI) is a typical electrolyte salt. The electrolyte salt may contain a lithium salt other than LiFSI. Examples of the lithium salt include LiBF₄, LiClO₄, LiAsF₆, LiCF₃SO₃, LiC(CF₃SO₂)₃, LiN(CF₃SO₂)₂(LiTFSI), and LiBC₄O₈. These can be used alone or in combination of two or more types thereof. As the electrolyte salt, LiFSI is preferably contained as a main component.

The electrolytic solution for a lithium metal secondary battery preferably contains LiFSI as the electrolyte salt in a concentration of preferably 1.0 mol/L or more and 3 mol/L or less, and more preferably 1.2 mol/L or more and 2.5 mol/L or less. When the concentration is 1.0 mol/L or less, it becomes difficult to suppress an increase in the thickness of lithium in the negative electrode, and when the concentration is 3 mol/L or more, it becomes difficult to cope with rapid charging because the viscosity of the electrolytic solution becomes high. In particular, when the electrolytic solution is applied to a BEV (Battery Electric Vehicle), 1.2 to 2.5 mol/L is appropriate in consideration of its use.

The electrolytic solution for a lithium metal secondary battery according to the present embodiment preferably has a viscosity ranging from 5 mPa·s to 12 mPa·s.

The organic solvent contains 1,2-dimethoxyethane (DME) as an essential component. When DME is contained in the organic solvent, solubility of the electrolyte salt (LiFSI or the like) is improved, and a conduction path of lithium ions in the electrolytic solution can be favorably secured. From the viewpoint of costs, DME is preferably used as the main solvent. From the viewpoint of solubility of LiFSI, the content of DME as a solvent component of the electrolytic solution is preferably at least 20 mol % or more. The content is more preferably 40 mol % or more, still more preferably 45 mol % or more, and most preferably 60 mol % or more because a sufficient resistance reduction effect can be obtained.

In order to achieve a high local concentration, the organic solvent preferably further contains a fluorinated ether in addition to 1,2-dimethoxyethane (DME). These have low coordination properties and can reduce the viscosity of the electrolytic solution while keeping solvation of DME stable, and therefore, can further reduce the internal resistance. Therefore, high-rate charging and discharging is possible. Examples of the fluorinated ether include 1,1,2,2-tetrafluoroethyl-2,2,3,3-tetrafluoropropyl ether (TTE) and a compound represented by the following formula (1). 1,1,2,2-tetrafluoro-1-(2,2,2-trifluoroethoxy) ethane may be also exemplified. In order to improve decomposition resistance and adjust the viscosity, a plurality of acyclic esters may be mixed.

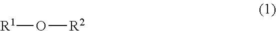

In the formula (1), R¹ and R² each independently represent a fluorinated hydrocarbon group such as a fluorinated alkyl group. The number of carbon atoms of R¹ and R² is not particularly limited, but may be, for example, 1 to 8. Examples of the compound represented by the formula (1) include 1,1,2,2-tetrafluoroethyl-2,2,2-trifluoroethyl ether.

The organic solvent may include an organic solvent other than those described above. For example, chain ethers such as 1,2-diethoxyethane, diethyl ether, 1-ethoxy-2-(2-methoxyethoxy) ethane, etc. may be included. Alternatively, the organic solvent may include ethylene carbonate (EC), propylene carbonate (PC), sulfolane (SL), dimethyl carbonate (DMC), diethyl carbonate (DEC), or ethyl methyl carbonate (EMC), etc., as long as the effect of the present invention is not impaired.

The organic solvent preferably includes 1,2-dimethoxyethane (DME) and 1,1,2,2-tetrafluoroethyl-2,2,3,3-tetrafluoropropyl ether (TTE). In this case, DME/LiFSI, a molar ratio of 1,2-dimethoxyethane (DME) as the organic solvent to lithium bis-fluorosulfonylimide (LiFSI) as the electrolyte salt, is preferably 1.5 to 2.3. TTE/(LiFSI+DME), a mass ratio of 1,1,2,2-tetrafluoroethyl-2,2,3,3-tetrafluoropropyl ether (TTE) as the organic solvent to a total amount (LiFSI+DME) of lithium bis-fluorosulfonylimide (LiFSI) and 1,2-dimethoxyethane (DME), is preferably 20% by mass or more and 60% by mass or less.

The first additive is a component that is coordinated to lithium metal to stabilize and form a thin film on the negative electrode. The electrolytic solution for a lithium metal secondary battery according to the present embodiment includes the first additive, whereby the additive gradually acts on the negative electrode (lithium metal layer) of the lithium metal secondary battery and the lithium metal deposited on the negative electrode while slowly decomposing. Thus, porosity formation during lithium deposition is reduced over a long period of time, and dendrite formation is continuously suppressed, which improves the durability of the lithium metal secondary battery.

The first additive is at least any one of N,N-dimethyltrifluoromethane-sulfonamide (DMTMSA) or N,N-dimethylsulfamoyl fluoride (DMSF). As the first additive, either DMTMSA or DMSF may be included in the electrolytic solution for a lithium metal secondary battery, and both DMTMSA and DMSF are preferably included. In particular, addition amounts thereof are preferably the same or DMSF>DMTMSA. While DMSF acts relatively fast on the lithium negative electrode, DMTMSA is less likely to decompose on the lithium negative electrode and acts for a longer period of time because of its slower decomposition rate. Therefore, it is preferable for the electrolyte for a lithium metal secondary battery to contain a greater amount of DMSF, which has a higher initial consumption rate, than DMTMSA. As a result, both the effect of suppressing an increase in the thickness of the negative electrode and the effect of improving the durability of the lithium metal secondary battery can be preferably obtained. Furthermore, when both DMSF and DMTMSA are contained, the effect of maintaining the action from the early stage to the late stage can be achieved when the endurance test is performed.

The content of the first additive in the electrolytic solution for a lithium metal secondary battery is 0.2 parts by mass or more when the total mass of the electrolyte salt and the organic solvent is 100 parts by mass. The content is preferably 5.0 parts by mass or less. As a result, the effects of the present invention are preferably obtained. The content is more preferably 0.5 part by mass or more and 2.0 parts by mass or less. When both DMTMSA and DMSF are included as the first additive, the content of the first additive means a total content of DMTMSA and DMSF.

The content of DMTMSA as the first additive is preferably 2.0 parts by mass or less. As a result, an initial resistance of the lithium metal secondary battery can be reduced, and the durability can be improved.

The content of DMSF as the first additive is preferably 5.0 parts by mass or less. As a result, it is possible to reduce the increase in resistance when the charge/discharge cycle of the lithium metal secondary battery is repeated.

The second additive is at least any one of lithium difluoro (oxalato) borate (LiFOB), lithium difluorophosphate (LiDFP), or LiPF₆. These may be used alone or in combination of two or more types thereof. In the case where LiFOB is contained as the second additive, an effect of removing residual moisture and suppressing porosity formation during Li deposition can be obtained. When LiDFP is contained as the second additive, it is possible to suppress deterioration of the positive electrode active material and improve durability. When LiPF₆ is contained as the second additive, it is possible to suppress deterioration of the positive electrode and improve durability.

The content of LiFOB as the second additive in the electrolytic solution for a lithium metal secondary battery is preferably 0.1 parts by mass or more and 5 parts by mass or less. The content of LiDFP in the electrolytic solution for a lithium metal secondary battery is preferably 0.1 parts by mass or more and 2 parts by mass or less. Similarly, the content of LiPF₆ in the electrolytic solution for a lithium metal secondary battery is preferably 0.1 parts by mass or more and 2 parts by mass or less. When the contents of LiDFP and LiPF₆ are 0.1 parts by mass or less, a sufficient effect cannot be obtained, and when the contents are 2 parts by mass or more, the solubility in the electrolytic solution is not sufficient, and a sufficient effect cannot be obtained even when the amount of the additive is increased. There is a possibility that the electrolytic solution is decomposed by a side reaction and an amount of gas generation increases. The definition of the content of the second additive means a part(s) by mass of the second additive when the total mass of the electrolyte salt and the organic solvent is 100 parts by mass, similarly to the definition of the content of the first additive.

The electrolytic solution for a lithium metal secondary battery according to the present embodiment may contain components other than those described above. For example, Ca (calcium) cations that remove residual moisture and stabilize Li deposition may be included. Sources of Ca (calcium) cations include, for example, Ca(TFSI)₂, Ca(FOB)₂, Ca(FSI)₂, and Ca(BF₄)₂. The electrolytic solution for a lithium metal secondary battery may contain known components that are used in electrolytic solutions for a lithium metal secondary battery in addition to the above. Examples thereof include a film forming material and a dispersant. Specifically, the following may be contained: Mg(FSI)₂, Mg(TFSI)₂, Ba(FSI)₂, Ba(TFSI)₂, Zn(FSI)₂, Zn(TFSI)₂, LiTFSI, LiNO₃, lithium nitrite, LiPO₂F₂, CsPF₆, and lithium sulfate as an alkali metal salt, propane sultone and ethylene sulphite as an organic additive, acetonitrile, adiponitrile, or butyronitrile as a nitrile-based compound, diphenyl sulfide, etc.

### <Lithium Metal Secondary Battery>

The electrolytic solution according to the present embodiment constitutes a lithium metal secondary battery. A specific configuration of the lithium metal secondary battery is not particularly limited except for the electrolytic solution, and a configuration used in known lithium metal secondary batteries can be used without limitation. In one typical embodiment, the lithium metal secondary battery includes a laminate including a positive electrode layer, a negative electrode layer, and an electrolyte layer disposed between the positive electrode layer and the negative electrode layer, and the electrolyte layer may include the electrolytic solution according to the present embodiment. The laminate is housed in an exterior body such as a laminate film.

The positive electrode layer is a layer containing a positive electrode active material. The positive electrode active material is not particularly limited as long as it is a material usable as a positive electrode active material of a lithium metal secondary battery. However, suitable amounts and combinations of the first additive are different for a polycrystalline positive electrode active material and a single particle positive electrode active material. In a polycrystalline positive electrode, a new surface is formed due to active material cracking during charge and discharge, and the consumption rate of a larger amount of DMTMSA or DMSF on the positive electrode is increased, and the effect of increasing the thickness of the negative electrode is less likely to be obtained due to a decrease in the added concentration. Therefore, when the addition amount of DMTMSA or DMSF is increased, as a result, a large amount of excess DMTMSA or DMSF remains, and thus there is a problem that the resistance of the cell increases during the endurance test. When a single particle positive electrode is used, for example, the addition amount of DMTMSA can be reduced to about 0.2% by mass to 2% by mass, which is the same amount as that of LiFOB or LiDFP as the second additive. As a result, B and P, which are constituent elements of an SEI film, also effectively act, and there is an advantage that a synergistic effect with the constituents of DMSF and DMTMSA is easily obtained. Therefore, the electrolytic solution of the present invention is particularly effective when a single-particle positive electrode active material is used.

Examples of the type of the positive electrode active material include a layered active material containing lithium, a spinel active material, an olivine active material, etc. Examples of the positive electrode active material include lithium cobalt oxide (LiCoO₂), lithium nickel oxide (LiNiO₂), LiNiₚMn_{q}CoᵣO₂ (p+q+r=1), LiNiₚAl_{q}CoᵣO₂ (p+q+r=1), lithium manganese oxide (LiMn₂O₄), dissimilar element-substituted Li—Mn spinel represented by Li₁₊ₓMn_{2-x-y}M_{y}O₄ (x+y=2, M=at least one selected from Al, Mg, Co, Fe, Ni, or Zn), lithium titanium oxide (an oxide containing Li and Ti), and lithium metal phosphate (LiMPO₄, M=at least one selected from Fe, Mn, Co, or Ni). The positive electrode layer may contain a binder, a conductive additive, and the like in addition to the positive electrode active material. A positive electrode current collector may be disposed adjacent to the positive electrode layer. The positive electrode current collector is not particularly limited as long as it is a material usable as a positive electrode current collector of the lithium metal secondary battery. Examples of the positive electrode current collector include aluminum, an aluminum alloy, stainless steel, nickel, iron, and titanium.

The negative electrode layer is a layer containing a negative electrode active material. As the negative electrode active material, for example, those including a lithium metal or a lithium alloy alone or a mixture thereof can be used. Examples of elements capable of forming an alloy with lithium metal include Al, Mg, K, Na, Ca, Sr, Ba, Si, Ge, Sb, Pb, Sn, In, Zn, etc. In addition to the above, a composite in which carbon and/or an organic substance is composited in lithium metal may be used. A negative electrode current collector may be disposed adjacent to the negative electrode layer. The negative electrode current collector is not particularly limited as long as it is a material usable as a negative electrode current collector of a lithium metal secondary battery. Examples of the negative electrode current collector include copper, a copper alloy, nickel, and stainless steel.

The electrolyte layer includes the electrolytic solution according to the above embodiment. The electrolyte layer may be formed by impregnating a separator, which is for preventing a short circuit between a positive electrode and a negative electrode, with an electrolytic solution. As the separator, a known material as a separator for lithium metal secondary batteries, such as a nonwoven fabric or a microporous film, can be used.

Although a preferred embodiment of the present invention has been described above, the present invention is not limited to the above embodiment, and modifications and improvements within a range capable of achieving the object of the present invention are included in the present invention.

### Examples

Hereinafter, the present invention will be described in detail with reference to Examples. However, the present invention is not limited to these Examples.

### [Preparation of Electrolytic Solutions for Lithium Metal Secondary Battery]

Electrolytic solutions for a lithium metal secondary battery according to Examples and Comparative Examples were prepared in the formulations shown in Tables 1 and 2 below. The abbreviations shown in Tables 1 and 2 are the same as those described in the above embodiment. In Tables 1 and 2, “part(s) by mass” means part(s) by mass when the total mass of the electrolyte salt and the organic solvent is 100 parts by mass. The water content of the electrolytic solution was 30 ppm or less as measured by a Karl Fischer method.

TABLE 1

| | | | Examples | | | | | | | | | | | |
|---|---|---|---|---|---|---|---|---|---|---|---|---|---|---|
| | | | 1 | 2 | 3 | 4 | 5 | 6 | 7 | 8 | 9 | 10 | 11 | 12 |
| Electrolyte | LiFSI | mol/L | 2.1 | 2.1 | 2.1 | 2.1 | 2.1 | 2.1 | 2.1 | 2.1 | 2.1 | 2.1 | 1.5 | 1.9 |
| salt | | | | | | | | | | | | | | |
| Organic | DME | Mol | 60 | 60 | 60 | 60 | 60 | 60 | 60 | 60 | 60 | 60 | 45 | 50 |
| solvent | | ratio | | | | | | | | | | | | |
| | TTE | Mol | 40 | 40 | 40 | 40 | 40 | 40 | 40 | 40 | 40 | 40 | 55 | 50 |
| | | ratio | | | | | | | | | | | | |
| First | DMTMSA | Part(s) | 0.2 | 1 | 2 | 0 | 0 | 0 | 0.2 | 1 | 1 | 1 | 1 | 10 |
| additive | | by mass | | | | | | | | | | | | |
| | DMSF | Part(s) | 0 | 0 | 0 | 0.2 | 1 | 2 | 0.2 | 1 | 2 | 2 | 2 | 0 |
| | | by mass | | | | | | | | | | | | |
| Second | LiFOB | Part(s) | 0 | 0 | 0 | 0 | 0 | 0 | 0 | 0.5 | 0.5 | 0.5 | 0.5 | 0 |
| additive | | by mass | | | | | | | | | | | | |
| | LiDFP | Part(s) | 0 | 0 | 0 | 0 | 0 | 0 | 0 | 0 | 0 | 0.3 | 0.3 | 0 |
| | | by mass | | | | | | | | | | | | |

| | | | | | | | | | | | | | |
|---|---|---|---|---|---|---|---|---|---|---|---|---|---|
| Li thickness | μm | 78 | 78 | 80 | 74 | 72 | 72 | 66 | 62 | 57 | 54 | 57 | 89 |
| Capacity retention | % | 90.48 | 94.17 | 94.17 | 95.12 | 95.12 | 95.12 | 95.69 | 96.08 | 96.56 | 96.85 | 96.85 | 89.58 |
| (150 cyc) | | | | | | | | | | | | | |
| Resistance increase | % | 102 | 102 | 102 | 105 | 105 | 107 | 100 | 100 | 100 | 100 | 103 | 102 |
| ratio (150 cyc) | | | | | | | | | | | | | |
| BOL specific | Ω · cm² | 18.85 | 19.62 | 19.62 | 19.82 | 19.02 | 19.02 | 19.94 | 19.31 | 17.40 | 17.47 | 16.65 | 25.59 |
| resistance (1 cyc) | | | | | | | | | | | | | |
| Gas amount inside | μL | 7 | 7 | 7 | 9 | 8 | 7 | <5 | <5 | <5 | <5 | <5 | 12 |
| cell (150 cyc) | | | | | | | | | | | | | |

TABLE 2

| | | | Comparative Examples | | | | | |
|---|---|---|---|---|---|---|---|---|
| | | | 1 | 2 | 3 | 4 | 5 | 6 |
| Electrolyte | LiFSI | mol/L | 2.1 | 1.5 | 2.1 | 2.1 | 1.2 | 2.1 |
| salt | | | | | | | | |
| Organic | DME | Mol | 60 | 45 | 60 | 60 | 0 | 0 |
| solvent | | ratio | | | | | | |
| | TTE | Mol | 40 | 55 | 40 | 40 | 0 | 0 |
| | | ratio | | | | | | |
| First | DMTMSA | Part(s) | 0 | 0 | 0 | 0 | 100 | 0 |
| additive | | by mass | | | | | | |
| | DMSF | Part(s) | 0 | 0 | 0 | 0 | 0 | 100 |
| | | by mass | | | | | | |
| Second | LiFOB | Part(s) | 0 | 0 | 0.5 | 0.5 | 0 | 0 |
| additive | | by mass | | | | | | |
| | LiDFP | Part(s) | 0 | 0 | 0 | 0.3 | 0 | 0 |
| | | by mass | | | | | | |

| | | | | | | | |
|---|---|---|---|---|---|---|---|
| Li thickness | μm | 101 | 106 | 96 | 95 | 90 | 80 |
| Capacity retention | % | 83.51 | 87.80 | 87.80 | 87.63 | 81.86 | 89.58 |
| (150 cyc) | | | | | | | |
| Resistance increase | % | 110 | 110 | 105 | 102 | 110 | 138 |
| ratio (150 cyc) | | | | | | | |
| BOL specific | Ω · cm² | 22.57 | 19.09 | 19.51 | 19.47 | 32.74 | 17.92 |
| resistance (1 cyc) | | | | | | | |
| Gas amount inside | μL | 40 | — | 20 | 16 | 7 | 12 |
| cell (150 cyc) | | | | | | | |

### [Preparation of Test Cell]

Using the electrolytic solutions according to the above Examples and Comparative Examples, test cells were produced by the following procedure.

### (Preparation of Positive Electrode)

2 wt % of acetylene black (AB) as an electron conductive material, 1.5 wt % of polyvinylidene fluoride (PVDF) as a binder, and polyvinyl pyrrolidone (PVP) as a dispersant were premixed with N-methyl-2-pyrrolidone (NMP) as a dispersion solvent, and wet-mixed with a planetary centrifugal mixer to obtain a premixed slurry. Subsequently, LiNi_{0.8}Co_{0.1}Mn_{0.1}O₂ (NCM 811) as the positive electrode active material and the obtained premixed slurry were mixed, and a dispersion treatment was performed using a planetary mixer to obtain a positive electrode paste. NCM 811 is composed of single particles and has a particle size of 4 μm in median diameter. The capacity per weight was 197 to 205 mAh/g. Next, the obtained positive electrode paste was applied to an aluminum positive electrode current collector having no primer layer, dried, and pressed by a roll press to obtain a positive electrode having an electrode material mixture layer with a thickness of 64 μm and a density of 3.3 to 3.5 g/cm³. Subsequently, the obtained positive electrode was dried at 120° C. in vacuum to form a positive electrode plate having a positive electrode material mixture layer. The obtained positive electrode plate was punched into a size of 30 mm×40 mm to obtain a positive electrode.

### (Preparation of Negative Electrode)

As the negative electrode, a clad material of a copper foil having a thickness of 10 μm and a lithium foil having a thickness of 20 μm was used. The negative electrode was punched out so as to have an electrode area of 34 mm×44 mm.

### (Separator Preparation)

As the separator, an alumina-coated polyethylene microporous film was used with the alumina-coated side facing the positive electrode side. The electrolytic solutions shown in Tables 1 and 2 were used.

### (Preparation of Lithium Metal Secondary Batteries)

A device including positive electrode-separator-negative electrode was introduced into a bag-shaped container formed by heat-sealing an aluminum laminate (manufactured by Dai Nippon Printing Co., Ltd.) for secondary batteries. Then, 350 μl of the electrolytic solution was injected, followed by vacuum-sealing. Thereafter, the container was left to stand at 45° C. for 5 hours, and restricted by a metal plate with a cushion so as to have a holding pressure of 1 MPa to prepare a cell. Charging and discharging (4.3 V to 2.65 V) of 0.1 C was performed twice to produce a lithium metal secondary battery of about 50 mAh.

### [Measurement of Li Thickness]

After completion of tests at 50 cycles by using the test cells prepared using the electrolytic solutions according to the above Examples and Comparative Examples, CCCV charging was performed at 4.3 V, and the obtained SOC was regarded as 100%. At this time, the device was taken out from the laminate cell, the positive electrode was peeled off, and the thickness of the separator and the negative electrode was measured with a micrometer. By subtracting the thicknesses of the negative electrode current collector foil and the separator from this value, the thickness of the negative electrode lithium metal layer in the charged state was obtained. The results are shown in Tables 1 and 2.

### [Capacity Retention Measurement]

The capacity retention was measured by using each of the test cells produced using the electrolytic solutions according to the above Examples and Comparative Examples. At 25° C., CCCV charging was performed to 4.3 V at a charging rate of 0.33 C (1/3 C), and CV charging was performed for 20 minutes. After leaving the test cell to stand for 10 minutes, the battery was discharged to 2.65 V at 0.33 C. This was regarded as a battery capacity of 100%. Thereafter, a charge/discharge cycle of 4.3 V to 2.65 V was performed 149 times in a thermostatic chamber at 25° C., with an upper limit voltage: 4.3 V, charging rate: 0.33 C, lower limit voltage: 2.65 V, a d discharging rate: 0.33 C. After the discharge was completed, the battery was left to stand for 6 hours, the rated capacity of 1/3 C of the 150th was measured, and the capacity retention was calculated. The results are shown in Tables 1 and 2.

### [Resistance Increase Ratio Measurement]

The rate of increase in resistance was measured using the test cells produced using the electrolytic solutions according to the above Examples and Comparative Examples. Specifically, resistance values were determined after the initial resistance measurement and the rated capacity measurement of the 150th cycle, and the ratio of the specific resistance in the 150th cycle/the initial resistance measurement value was determined. The results are shown in Tables 1 and 2.

### [BOL Specific Resistance Measurement]

BOL specific resistance was measured using each of the test cells produced using the electrolytic solutions according to the above Examples and Comparative Examples. Specifically, SOC was set to 50% by charging 50% of the discharge capacity at the time of measuring the initial capacity. From this voltage, 4.5 C discharge was performed for 10 seconds, and the resistance value was calculated. This resistance value was divided by the electrode area of the positive electrode of 12 cm², and the specific resistance Ω·cm² was calculated. The results are shown in Tables 1 and 2.

### [Measurement of Gas Quantity Inside Cell]

By using each of the test cells produced using the electrolytic solutions according to the above Examples and Comparative Examples, a quantity of gas inside the cell after 150 charge and discharge cycles was measured. Specifically, the following procedure was performed. First, a laminate cell after the completion of the durability test was adjusted to SOC 0, and a small cut was made in the laminate cell to form a hole. Next, argon gas was introduced into the cell, a mixed gas containing argon expelled from the inside of the cell was measured by gas chromatography, and the gas quantities of respective components were derived from calibration curves of the respective components while identifying the respective components. The obtained quantities were summed to obtain the generated gas quantity. The results are shown in Tables 1 and 2.

What is claimed is:

1. An electrolytic solution for a lithium metal secondary battery, comprising an electrolyte salt, an organic solvent, and at least one first additive,
the electrolyte salt comprising lithium bis-fluorosulfonylimide (LiFSI),
the organic solvent comprising 1,2-dimethoxyethane (DME),
the at least one first additive being at least any one of N,N-dimethyltrifluoromethane-sulfonamide (DMTMSA) or N,N-dimethylsulfamoyl fluoride (DMSF),
wherein the electrolytic solution for a lithium metal secondary battery comprises the first additive in an amount of 0.2 parts by mass or more when a total mass of the electrolyte salt and the organic solvent is 100 parts by mass.

2. The electrolytic solution for a lithium metal secondary battery according claim 1, wherein the electrolytic solution for a lithium metal secondary battery comprises the first additive in an amount of 5.0 parts by mass or less when the total mass of the electrolyte salt and the organic solvent is 100 parts by mass.

3. The electrolytic solution for a lithium metal secondary battery according to claim 1,
wherein the first additive comprises both N,N-dimethyltrifluoromethane-sulfonamide (DMTMSA) and N,N-dimethylsulfamoyl fluoride (DMSF), and
a content (mass ratio) of N,N-dimethyltrifluoromethane-sulfonamide (DMTMSA) is smaller than a content (mass ratio) of N,N-dimethylsulfamoyl fluoride (DMSF).

4. The electrolytic solution for a lithium metal secondary battery according to claim 1, further comprising, as a second additive, at least any one of lithium difluoro (oxalato) borate (LiFOB), lithium difluorophosphate (LiDFP), or LiPF₆.

5. The electrolytic solution for a lithium metal secondary battery according to claim 1, wherein a content of 1,2-dimethoxyethane (DME) in the organic solvent is 20 mol % or more.

6. The electrolytic solution for a lithium metal secondary battery according to claim 1, further comprising a fluorinated ether as the organic solvent.

7. The electrolytic solution for a lithium metal secondary battery according to claim 1, wherein a concentration of lithium bis-fluorosulfonylimide (LiFSI) as the electrolyte salt in the electrolytic solution for a lithium metal secondary battery is 1.2 mol/L or more and 2.5 mol/L or less.
